(19) United States
(12) Patent Application Publication
(10) Pub. No.: US 2012/0055374 A1
(43) Pub. Date: Mar. 8, 2012

(54) FLY ASH USED IN CONSTRUCTION APPLICATION

(76) Inventors: William B. Spence, Pittsburgh, PA (US); Chris A. Forsha, Blairsville, PA (US)

(21) Appl. No.: 13/224,459

(22) Filed: Sep. 2, 2011

Related U.S. Application Data
(60) Provisional application No. 61/379,855, filed on Sep. 3, 2010.

(51) Int. Cl. C04B 18/06; B29C 43/32

(52) U.S. Cl. 106/707; 264/122

(57) ABSTRACT

A masonry product is formed from a composition comprising a blend of fly ash and kiln dust. A process for forming the product comprises mixing fly ash, kiln dust, and water; and applying a pressure.

### CLAIM OF PRIORITY

This application claims priority from Provisional Application Ser. No. 61/379,855 which was filed on Sep. 3, 2010; and which is hereby incorporated by reference in its entirety.

### BACKGROUND OF THE DISCLOSURE

The present disclosure relates to a composition comprising fly ash which may be used to produce a cement replacement. It finds particular application in construction, and will be described with particular reference thereto. In particular, the present exemplary embodiment can be used as a replacement for cement or concrete in construction applications.

Fly ash is a residue produced during the combustion of coal. Compositions of fly ash vary significantly but fly ash is generally rich in both silicon dioxide (SiO₂) and calcium oxide (CaO). Fly ash may also include toxic components such as arsenic, beryllium, boron, cadmium, chromium, cobalt, lead, manganese, mercury, molybdenum, selenium, strontium, thallium, vanadium, dioxins, and/or polycyclic aromatic hydrocarbons. Fly ash is a regulated substance because of these toxic materials. In the soil additive context, metal loading of the soil can be particularly problematic.

Classes of fly ash include Class F fly ash and Class C fly ash. Class F fly ash is typically produced by burning harder, older anthracite and bituminous coal. Class F fly ash contains less than 10% CaO. Class C fly ash is typically produced by burning younger lignite or sub bituminous coal. Class C fly ash generally contains more than 20% CaO. Additionally, alkali and sulfate contents are generally higher in Class C fly ash than in Class F fly ash.

Compositions comprising fly ash are known for use such as in cement mixtures and for treating sludge and other industrial wastes.

Some companies which produce compositions of fly ash include Pitt Mining Biosolids which sells a blend of sewage sludge and kiln dust. Harsco Minerals sells a product called Mineral CSA's product which is produced by blending a ground steel slag with a bag-house lime.

The present disclosure relates to a blend of fly ash and kiln dust, which create a superior masonry product to those utilizing cement products. This blend creates a stronger, more malleable surface and far superior shrinkage rate than existing cement products.

Kiln dust is a byproduct formed in a kiln during a manufacturing process. Cement kiln dust is formed during the manufacture of cement while kiln dust is formed during the manufacture of lime. Kiln dust is highly alkaline and is generally in the form of very fine particles. Kiln dust is a regulated material because of ambient dust concerns, e.g. respiratory problems in humans and animals, due to its small particle size.

There exists a need for a masonry product with improved properties which utilizes both fly ash and kiln dust.

### SUMMARY OF THE DISCLOSURE

Fly ash is a regulated material which is monitored due to the metals loading of the soils. This is required because the primary use of fly ash has been for fill material and or soil conditioning which tend to involve large amounts of material.

Fly ash, which is readily available and which is approved as an additive to cement blends, contains all of the attributes to replace the need for cement in masonry mixes. Iron and alkalinity exists in the fly ash material which has been fired to produce the same attributes which are contained in cement products. Kiln dust can be added to increase the alkalinity of the blend to the required levels for a complete exothermic chemical reaction.

A preferred source of fly ash is the Scrubgrass Generating Facility, which is approved for beneficial use for fill material, alkaline addition and soil enhancement certification #CA007.

In accordance with another aspect of the disclosure, the process of blending fly ash and kiln dust begins with the delivery of kiln dust by a pneumatic tanker and the transfer of the kiln dust to a 50-ton silo. The 50-ton silo is equipped with a bag house air filtering device which serves as the air control for the entire process. The atmosphere in the process building is re-circulated through this device and automatic shakers deposit the captured kiln dust into the silo for use in the process.

Fly ash is deposited into a receiving bin and fed onto a transfer belt which is enclosed and connected to an air recirculation system.

Kiln dust in turn is auger fed to an enclosed belt and is deposited on to the fly ash at a controlled rate which may be equal to about five times the volume carried by the transfer belt.

Both materials, i.e. the kiln dust and fly ash, then enter a blender which is connected to an air quality control device. Both materials are blended and discharged on to the radial belt where the material will be discharged to a bulk stock pile or will be directed to bagger equipment. The material directed to bagger equipment is preferably packaged into 40-lb. bags and placed onto pallets of about 50 bags per pallet, then wrapped with packing plastic wrap. The pallets are then stored until shipping. The bulk material is typically stored under cover until shipping.

In accordance with one aspect of the disclosure, a masonry product including from about 85% to about 95% by volume of fly ash and from about 5% to about 15% by volume of kiln dust is provided.

In accordance with another aspect of the disclosure, a process of forming a masonry product in a mold includes providing coarse fly ash to the mold; providing pulverized fly ash to the mold; providing kiln dust to the mold; providing water to the mold and applying pressure to the mold.

In accordance with another aspect of the disclosure, a masonry product includes about 90% by volume of class C fly ash and about 10% by volume of lime kiln dust.

In accordance with still another aspect of the present disclosure, the fly ash may comprise Class C fly ash, Class F fly ash, or a mixture thereof.

In accordance with another aspect of the disclosure, fly ash has been developed as a replacement for cement and concrete products for use in construction applications. The consistency, strength and availability of fly ash far exceed that of aggregate materials.

Still other features and benefits of the present disclosure will become apparent from the following detailed description.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flow chart for a process in accordance with the present disclosure for producing a blend of fly ash and kiln dust.

FIG. 2 shows the composition of fly ash brick in accordance with one aspect of the disclosure;

FIG. 3 shows the composition of pulverized fly ash in accordance with another aspect of the disclosure; and

FIG. 4 shows compression strength test results for fly ash brick.

### DETAILED DESCRIPTION OF THE DISCLOSURE

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

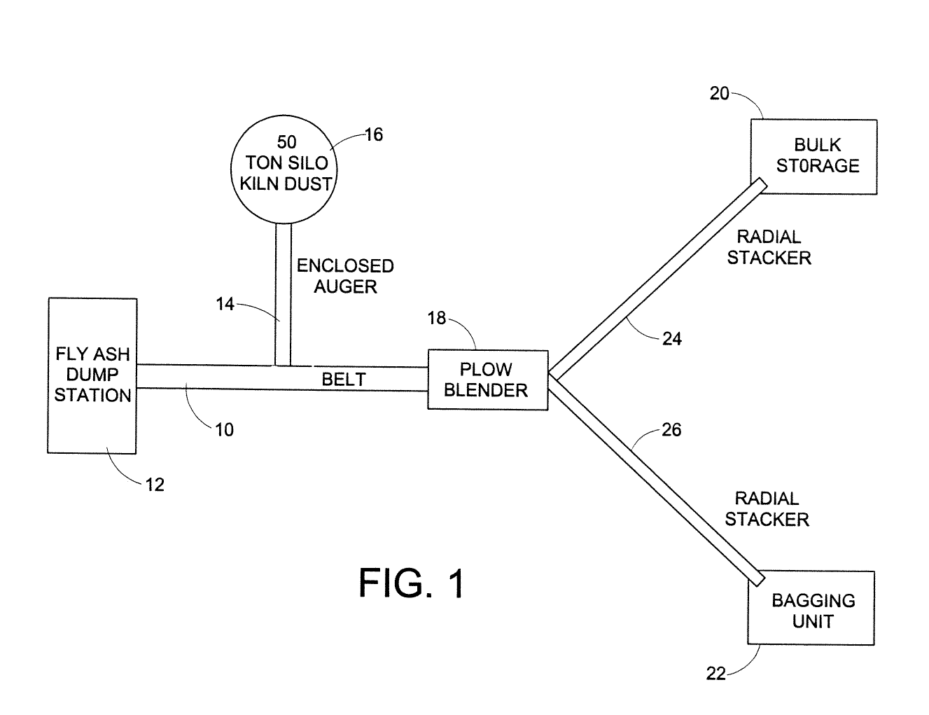

Referring now to FIG. 1, in accordance with a preferred embodiment of the disclosure, a process of using fly ash in combination with kiln dust to produce a cement replacement is shown. Fly ash is fed to a transfer belt 10 from a fly ash dump station 12. The transfer belt may be enclosed and connected to an air-recirculation system. Kiln dust may be fed to the transfer belt via an enclosed auger 14 from a silo 16. The material on the transfer belt is then transferred to a plow blender 18. The blender may also be connected to an air-recirculation system. The contents of the blender are blended and discharged to radial belts. The blend may be fed to bulk storage 20 or a bagging unit 22 via radial stackers 24, 26.

In some embodiments, a portion of the blend is sent to bulk storage 20 while the remainder is sent to the bagging unit 22. At the bagging unit, the blend may be packaged into bags, such as 40 pound bags. The bags may be stacked onto pallets of about 50 bags and wrapped with plastic packing wrap. Other sizes and amounts of bags are also contemplated by the disclosure. The portion sent to bulk storage may be stored under cover until bagging and shipping.

The fly ash may be Class F fly ash, Class C fly ash, or a mixture thereof. In some embodiments, the fly ash may be present in an amount of from about 85% to about 95% of the total composition volume. Kiln dust may comprise from about 5% to about 15% of the total volume. The cement replacement preferably contains class “C” fly ash, since Class “F” fly ash contains higher concentrations of metals and is lower in calcium carbonate content.

Fly ash can serve as a replacement for limestone aggregate material in cement and concrete products or as a replacement for cement and concrete products. The consistency, strength and availability of fly ash far exceed that of aggregate materials. Typical products which are improved by the use of fly ash in lieu of aggregate materials include, but are not limited to: facing stone, retaining wall block, cement brick, paving stone, patio stone, cement pottery, cement patio furniture, parking stops, concrete barriers, concrete footers, cement floors, mortar, road base material and structural back fill material.

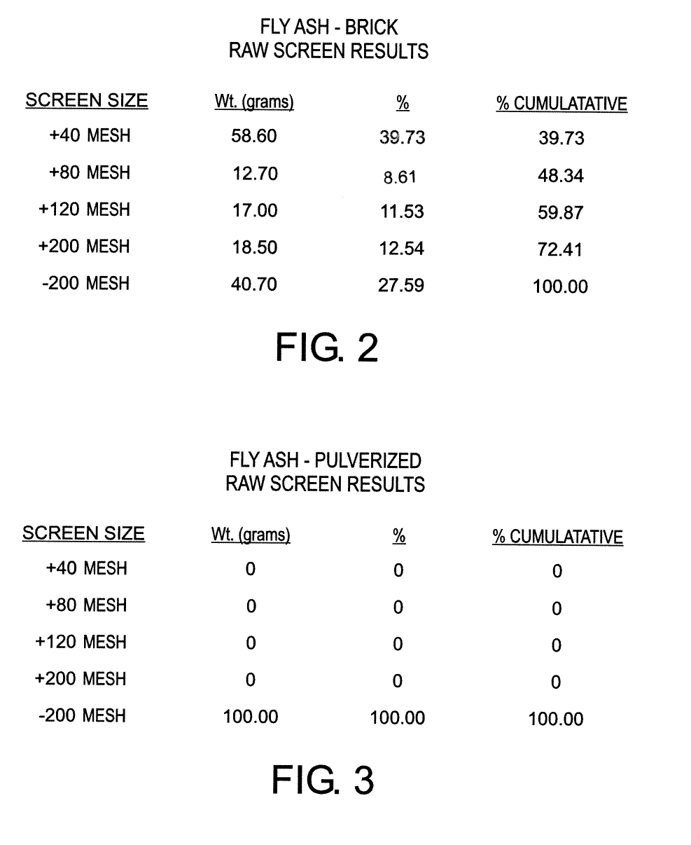

Referring to FIG. 2, the process of forming fly ash brick begins by crushing the fly ash material to coarse screen sizes of: +40 MESH—(39.73%), +80 MESH—(8.61%); +120 MESH—(11.53%); +200 MESH—(12.54%); and −200 MESH—(27.59%). Referring to FIG. 3, 45% of the fly ash is then pulverized to form −200 MESH (that is, the fly ash is pulverized to form 100%-200 MESH).

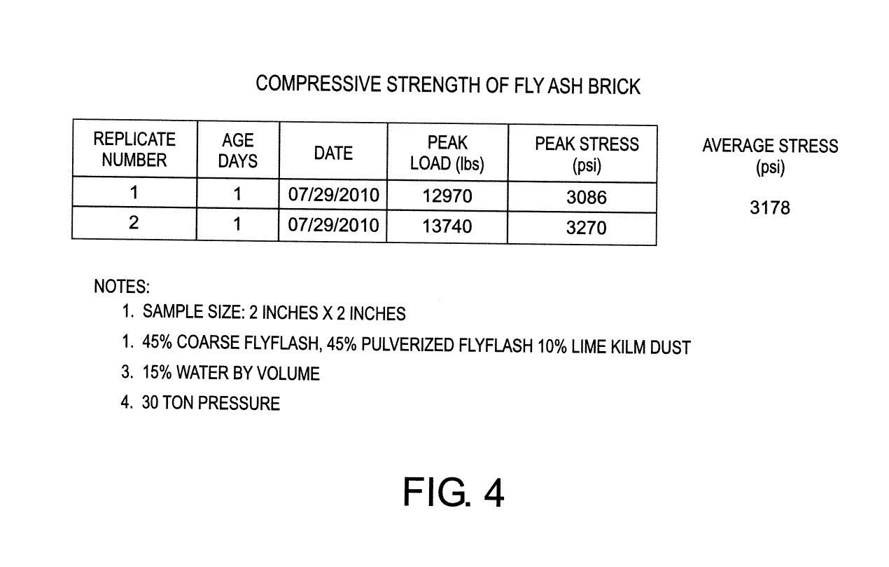

The 45% coarse fly ash then is combined with the 45% pulverized fly ash. Referring to FIG. 4, about 10% lime kiln dust is then added. Then, 15% water by volume is then added to the total dry volume. The combination is placed in a form and up to about 60,000 lb. pressure is applied. This blend and process produces a masonry product with an average 3,178 psi rating. FIG. 4 illustrates typical test results including peak load and peak stress for cement or concrete compositions, including various percentages, such as 45% coarse fly ash, 45% pulverized fly ash and 10% lime kiln dust. Class C fly ash is used in these combinations. The sample brick size is 2 inches×2 inches×2 inches. Typically, the peak stress of cement or concrete is about 2,000 psi. The compositions in FIG. 4 withstood peak stresses of from 3,086 to 3,270 psi (average peak stress of 3,178 psi).

This process is unique as it reduces the particle size of the material to increase the chemical reaction as to permit the bonding of the materials into a complete mass to maximize the tension strength of the shape being produced. Yet utilizing larger particles to form the desired shape and give body to the shape being produced.

The kiln dust may be cement kiln dust, lime kiln dust, or a mixture thereof. Lime kiln dust, which is preferred, is the dust collected of the kilns which produce hydrated lime, a very high alkaline material. Cement kiln dust is the dust collected from grinding the manufactured “klingers” used to produce cement. In some embodiments, the kiln dust may be present in an amount of from about 5% to about 15% of the total composition volume. In some embodiments, the kiln dust is high calcium lime kiln dust such as produced by Graymont in Pleasant Gap, Pa.

The use of fly ash in these applications increases strength, reduces shrinkage and reduces the amount of cement required in the mixture formula. Fly ash provides a low cost superior material to replace aggregate material. Portland and similar cements react with water (hydrate) to create a gel that hardens by absorbing carbon dioxide. As it hardens, the cement binds aggregates (typically sand and crushed stone) together, creating concrete. When Portland cement cures, it leaves behind some hydrated lime. Adding fly ash allows that hydrated lime to cure as well (as in the Roman walls), making the concrete stronger and less porous.

Fly ash also increases the durability of concrete and can also be used to shrink its environmental footprint by reducing the amount of Portland cement in the mix. Nearly a ton of carbon dioxide is emitted to produce each ton of Portland cement. Mixes in which up to 25% of the cement is replaced by fly ash are being developed, and some designers are specifying over 50% substitution for certain applications.

The exemplary embodiments have been described with reference to the preferred embodiments. Obviously, modifications and alterations will occur to others upon reading and understanding the preceding detailed description. It is intended that the exemplary embodiments be construed as including all such modifications and alterations.

1. A masonry product comprising:
from about 85% to about 95% by volume of fly ash; and
from about 5% to about 15% by volume of kiln dust.

2. The masonry product of claim 1, wherein the fly ash is Class C fly ash.

3. The masonry product of claim 1, wherein the kiln dust is lime kiln dust.

4. The masonry product of claim 1, wherein the composition comprises about 90% by volume of fly ash.

5. The masonry product of claim 1, wherein the composition comprises about 10% by volume of kiln dust.

6. The masonry product of claim 1, wherein the volumetric ratio of fly ash to kiln dust is about 9:1.

7. The masonry product of claim 1, wherein about 50% of the fly ash has a particle size of −200 MESH.

8. The masonry product of claim 1, wherein the masonry product is a facing stone, a retaining wall block, a paving stone, a patio stone, pottery, patio furniture, a parking stop, a barrier, a footer, a floor, or a mortar.

9. The masonry product of claim 1, wherein the masonry product is a brick.

10. The masonry product of claim 1, wherein the product is formed by a process comprising:
providing coarse fly ash to a mold;
providing pulverized fly ash to the mold;
providing kiln dust to the mold;
providing water to the mold; and
applying a pressure to the mold.

11. The masonry product of claim 11, wherein the amount of coarse fly ash is roughly equal to the amount of pulverized fly ash.

12. The masonry product of claim 1, wherein the peak stress of the masonry product is from about 3,086 psi to about 3,270 psi.

13. A process of forming a masonry product in a mold, the process comprising:
providing coarse fly ash to the mold;
providing pulverized fly ash to the mold;
providing kiln dust to the mold;
providing water to the mold; and
applying a pressure to the mold.

14. The process of claim 13, wherein the step of applying pressure to the mold includes applying a pressure of about 60,000 pounds.

15. The process of claim 13, wherein the coarse fly ash and pulverized fly ash are Class C fly ash.

16. The process of claim 13, wherein kiln dust is lime kiln dust.

17. The process of claim 13, wherein the contents of the mold comprise about 45% by volume coarse fly ash, about 45% by volume of pulverized fly ash, about 10% by volume of kiln dust, and about 15% by volume of water prior to the application of the pressure.

18. The process of claim 13, wherein the coarse fly ash has the following particle size distribution:
about 39.73% by volume of +40 MESH;
about 8.61% by volume of +80 MESH;
about 11.53% by volume of +120 MESH;
about 12.54% by volume of +200 MESH; and
about 27.59% by volume of −200 MESH.

19. A masonry product comprising:
about 90% by volume of Class C fly ash; and
about 10% by volume of lime kiln dust.

20. The masonry product of claim 19, wherein the Class C fly ash consists of coarse fly ash and pulverized fly ash in about equal amounts.

21. The masonry product of claim 19, wherein the peak stress is from about 3,086 psi to about 3,270 psi.
